(19) United States
(12) Patent Application Publication
(10) Pub. No.: US 2024/0287215 A1
(43) Pub. Date: Aug. 29, 2024

(54) METHOD FOR PREPARING A COMPOSITION COMPRISING AT LEAST THE MIXTURE OF AT LEAST ONE PEROXYDICARBONATE AND AT LEAST ONE PEROXYESTER

(71) Applicant: ARKEMA FRANCE, Colombes (FR)

(72) Inventors: Markus BRANDHORST, PIERRE-BENITE CEDEX (FR); Isabelle TARTARIN, VENETTE (FR)

(21) Appl. No.: 17/997,743

(22) PCT Filed: May 20, 2021
(86) PCT No.: PCT/FR2021/050915

§ 371 Date: Mar. 7, 2023

(30) Foreign Application Priority Data
May 20, 2020 (FR) FR2005309

(51) Int. Cl. C08F 4/38; C08F 14/06

(52) U.S. Cl. CPC C08F 4/38; C08F 14/06

(57) ABSTRACT

The present invention relates to a process for the preparation of a composition of organic peroxides comprising the mixture of at least one peroxydicarbonate and of at least one peroxyester, preferably at least one hydroxyperoxyester; said composition being prepared before being brought into contact with one or more monomers comprising ethylenic unsaturations, preferably one or more halogenated vinyl monomers, and more preferentially vinyl chloride.

The invention also relates to a process for the polymerization of one or more ethylenically unsaturated monomers successively comprising the preparation of the composition, as defined above, and bringing said composition into contact with one or more ethylenically unsaturated monomers.

The present invention relates to a process for the preparation of a composition of organic peroxides comprising the mixture of at least one peroxydicarbonate and of at least one peroxyester, preferably at least one hydroxyperoxyester; said composition being prepared before being brought into contact with one or more monomers comprising ethylenic unsaturations, preferably one or more halogenated vinyl monomers, and more preferentially vinyl chloride.

The invention also relates to a process for the polymerization of one or more ethylenically unsaturated monomers successively comprising the preparation of the composition, as defined above, and bringing said composition into contact with one or more ethylenically unsaturated monomers.

The present invention also relates to a halogenated vinyl polymer obtained by polymerization of at least one halogenated ethylenically unsaturated monomer in the presence of the composition as defined above.

Organic peroxides, in the liquid or solid form, are commonly used as polymerization initiators for ethylenically unsaturated monomers for the synthesis of various types of polymers, for example halogenated vinyl polymers, such as polyvinyl chloride.

However, their use frequently presents a certain number of problems. This is because organic peroxides generally constitute highly unstable entities as they decompose relatively easily under the action of a slight contribution of heat, of mechanical energy (friction or impact) and/or of incompatible contaminants. Thus, in the event of uncontrolled elevation of their storage temperature, some organic peroxides can undergo an autoaccelerated exothermic decomposition which can result in fires and/or violent explosions. In addition, under these conditions, some of these organic peroxides can release combustible vapours capable of reacting with any source of ignition which can drastically increase, indeed even accelerate, the risks of violent explosion. The result of this is that it is important to take appropriate precautionary measures in terms of safety during the storage and transportation of organic peroxides.

In order to overcome these various disadvantages, organic peroxides are sometimes stored at storage temperatures far below 0° C. before being used as polymerization initiators. Thus, organic peroxides are in particular packaged in the form of aqueous emulsions which can comprise antifreezes. This is because the presence of water makes it possible both to absorb and to dissipate the energy generated in the event of exothermic decompositions of organic peroxides, while the role of the antifreeze is to keep the emulsion in the liquid form, at temperatures of less than −10° C., generally of less than −15° C., which makes it possible to limit the risks of an involuntary exothermic decomposition of organic peroxides.

The aqueous emulsions generally contain, in addition, at least one emulsifier having the advantage of lowering the interfacial tension between the aqueous phase and the organic peroxide with the aim of facilitating the dispersion of the peroxide in the form of droplets and of maintaining the size of them over time. This is because, over time, the peroxide droplets can agglomerate together, bringing about an increase in their mean size and in their maximum size which can result, in some cases, in a total or partial phase separation and consequently in an overall destabilization of the emulsion.

Furthermore, mixtures of organic peroxides can also be used as polymerization initiators. To do this, the organic peroxides can be injected separately into the reaction medium containing the ethylenically unsaturated monomers during the polymerization or can be prepared upstream in a separate reactor in order to be added at the start of the polymerization. In other words, in some cases, a mixture of the organic peroxides, also known as premix, is prepared upstream in a suitable reactor before being added to the polymerization reactor. Such peroxide premixes are generally packaged in aqueous emulsions.

However, the preparation of these premixes generally takes place at a temperature greater than the storage temperature of the organic peroxides, that is to say at a temperature at which the organic peroxides risk being decomposed. In the same way, such premixes can also remain several hours, indeed even several days, before they are used, in the reactor in which they were prepared at a temperature greater than the storage temperature of the organic peroxides, which increases the risks of thermal decomposition of the organic peroxides.

Thus, the preparation of premixes of organic peroxides generally results in unstable compositions in which the organic peroxides are capable of decomposing as a function of the temperature, which results in a decrease in the amount of free radicals capable of being produced during the polymerization, which can result in a fall in the quality of the polymer obtained.

One of the objectives of the present invention is thus to prepare mixtures of organic peroxides not exhibiting the disadvantages described above, which are in particular stable thermally and over time.

In particular, one of the aims of the present invention is to implement a process making it possible to prepare mixtures of organic peroxides, which are stable, in which the thermal degradation (or decomposition) of the peroxides is minimized. In other words, one of the aims of the invention is to develop a process capable of ensuring, indeed even of improving, the activity of the organic peroxides during the polymerization.

A subject-matter of the present invention is thus a process for the preparation of a composition of organic peroxides comprising the mixing of at least one peroxydicarbonate and of at least one peroxyester before bringing said composition into contact with one or more ethylenically unsaturated monomers.

In particular, the process according to the invention comprises a stage of mixing at least one peroxydicarbonate and at least one peroxyester before bringing the composition thus obtained into contact with one or more ethylenically unsaturated monomers intended to polymerize together.

The process according to the invention thus exhibits the advantage of resulting in a stable composition in which the thermal degradation of the organic peroxides is minimized as a function of the time.

The process according to the invention makes it possible to prepare, upstream of their introduction into a polymerization reactor, mixtures of organic peroxides which can be stored and transported, at a temperature greater than that of the storage temperature of the organic peroxides, in a stable way to the site of production of the final polymer in order to be able to be used as is as polymerization initiators.

In particular, the process according to the invention makes it possible to prepare a stable composition of organic peroxides in a suitable reactor occurring on the site of production of the final polymer, at a temperature greater than that of the storage temperature of the organic peroxides, and to leave it to stand within such a reactor in complete safety for a greater or shorter period of time before being used effectively as polymerization initiators.

In other words, the process makes it possible to minimize the formation of free radicals in the premix of organic peroxides, which makes it possible to ensure the quality of the polymer obtained and also a better yield.

The composition obtained by the process according to the invention can thus be transported in complete safety within the factory for production of polymers, in particular from one point to the other of the factory, and can result in polymeric materials of good quality.

More particularly, the addition of the peroxyester makes it possible to effectively stabilize the peroxydicarbonate.

Furthermore, the process according to the invention results in a composition capable of bringing about a more homogeneous distribution of the organic peroxides in the polymerization reactor, which improves the reaction time and promotes a polymer of better quality being obtained. Such a homogeneity has in particular been observed with respect to the addition of the peroxyester to a polymerization reactor comprising the peroxydicarbonate.

Furthermore, the process according to the invention can advantageously be carried out within the factory for production of polymers, which constitutes a saving in time from an industrial viewpoint.

The composition of organic peroxides, which is obtained with the process according to the invention, can advantageously be maintained at a higher temperature than the storage temperature for several hours, indeed even several days, which offers greater flexibility to the operator for the production of polymers.

In particular, the possibility of preserving such a composition at a temperature greater than the storage temperature of the peroxides for a long period of time makes it possible to economize on the amounts of organic peroxides necessary for the production of the polymer.

The process according to the invention also exhibits the industrial advantage of being able to prepare a stable composition which makes it possible to initiate the polymerization of ethylenically unsaturated monomers at similar rates under conditions reproducible from one polymerization reactor to another and to obtain polymers having a similar quality and/or uniform mechanical and chemical properties.

Furthermore, the composition obtained by the process according to the invention can be used several times over several hours, indeed even several days, after its preparation, while retaining good stability.

Another subject-matter of the invention is a process for the polymerization of one or more ethylenically unsaturated monomers successively comprising:
(i) the preparation of a composition as defined above,
(ii) bringing said composition into contact with one or more ethylenically unsaturated monomers.

The polymerization process makes it possible to prepare a polymer of good quality under reproducible conditions This is because the polymerization reaction time is improved.

Another subject-matter of the invention is the use of the composition as defined above for the polymerization or the copolymerization of one or more ethylenically unsaturated monomers, in particular vinyl monomers, preferably halogenated vinyl monomers, and more preferentially vinyl chloride.

The composition comprising the mixture of organic peroxides can thus be used as polymerization initiators for the synthesis of polymers or of copolymers obtained from one or more ethylenically unsaturated monomers.

In addition, the invention also relates to a halogenated vinyl polymer obtained by polymerization of at least one halogenated ethylenically unsaturated monomer in the presence of the composition as described above.

Other characteristics and advantages of the invention will become more clearly apparent on reading the description and the examples which follow.

In what will follow and unless otherwise indicated, the limits of a range of values are included in this range.

The expression “at least one” is equivalent to the expression “one or more”.

Within the meaning of the present invention, the expression “Rⁿ and R^{m} represent a Cₓ-Cₓ₄ alkyl group” means that Rⁿ and R^{m} can represent Cₓ, Cₓ₁, Cₓ₂, Cₓ₃ and Cₓ₄, that is to say that the limits Cₓ and Cₓ₄ are included.

### Process for the Preparation of the Composition

As indicated above, the process according to the invention comprises the mixing of at least one peroxydicarbonate and of at least one peroxyester before bringing said composition into contact with one or more ethylenically unsaturated monomers.

Preferably, the peroxydicarbonate corresponds to the following formula (I):

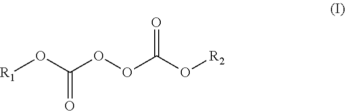

in which formula (I) R¹ and R², which are identical or different, represent a linear, branched or cyclic C₁-C₂₀ alkyl group which can comprise one or more heteroatoms, preferably one or more oxygen atoms.

Preferably, R¹ and R², which are identical or different, represent a linear, branched or cyclic C₁-C₁₆, more preferentially C₃-C₁₂, in particular C₃-C₁₀, alkyl group which can comprise, preferably be interrupted by, one or more heteroatoms, preferably one or more oxygen atoms.

Preferably, R¹ and R², which are identical or different, represent a linear C₁-C₁₆, more preferentially C₃-C₁₂, in particular C₃-C₁₀, alkyl group which can comprise one or more heteroatoms, preferably one or more oxygen atoms.

Preferably, R¹ and R², which are identical or different, represent a branched C₁-C₁₆, more preferentially C₃-C₁₂, in particular C₃-C₁₀, alkyl group which can comprise one or more heteroatoms, preferably one or more oxygen atoms.

Preferably, R¹ and R², which are identical or different, represent a cyclic C₃-C₁₂, in particular C₃-C₁₀, alkyl group which can comprise one or more heteroatoms, preferably one or more oxygen atoms.

Preferably, R¹ and R², which are identical or different, represent an alkyl group, as defined above, which can be interrupted by one or more heteroatoms, preferably one or more oxygen atoms.

Within the meaning of the present invention, the term “cyclic alkyl group” is understood to mean a linear or branched alkyl group comprising a ring, preferably an aromatic ring, preferably comprising 5 or 6 ring members.

Preferably, the heteroatom is an oxygen atom.

Preferably, R¹ and R² are identical and represent a linear or branched, preferably branched, C₂-C₁₆, in particular C₃-C₁₂, more preferentially still C₃-C₁₀, alkyl group.

Preferentially, R¹ and R² are identical and represent a linear or branched, preferably branched, C₂-C₈ alkyl group.

The peroxydicarbonate is preferably chosen from the group consisting of di(2-ethylhexyl) peroxydicarbonate, di(sec-butyl) peroxydicarbonate, bis(1-methylheptyl) peroxydicarbonate, di(n-propyl) peroxydicarbonate, di(3-methoxybutyl) peroxydicarbonate, diethyl peroxydicarbonate and their mixtures, preferably di(2-ethylhexyl) peroxydicarbonate and di(sec-butyl) peroxydicarbonate.

Advantageously, the peroxydicarbonate is chosen from the group consisting of di(2-ethylhexyl) peroxydicarbonate, sold under the trade name Luperox® 223, and di(sec-butyl) peroxydicarbonate, sold under the trade name Luperox® 225.

Preferably, the peroxyester corresponds to the following formula (II):

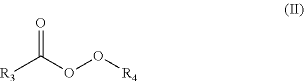

in which formula (II) R³ and R⁴, which are identical or different, represent a linear, branched or cyclic C₁-C₂₀ alkyl group which can comprise one or more heteroatoms, preferably one or more oxygen atoms, and/or be optionally substituted by one or more hydroxyl groups.

Preferably, R³ and R⁴, which are identical or different, represent a linear or branched C₄-C₂₀, preferably C₇-C₂₀, preferably C₇-C₁₆, in particular C₇-C₁₀, alkyl group which can comprise one or more heteroatoms, preferably one or more oxygen atoms, and/or be optionally substituted by one or more hydroxyl groups.

Preferably, R³ and R⁴, which are identical or different, represent a linear C₄-C₂₀, preferably C₇-C₂₀, preferably C₇-C₁₆, in particular C₇-C₁₀, alkyl group which can comprise one or more heteroatoms, preferably one or more oxygen atoms, and/or be optionally substituted by one or more hydroxyl groups.

Preferably, R³ and R⁴, which are identical or different, represent a branched C₄-C₂₀, preferably C₇-C₂₀, preferably C₇-C₁₆, in particular C₇-C₁₀, alkyl group which can comprise one or more heteroatoms, preferably one or more oxygen atoms, and/or be optionally substituted by one or more hydroxyl groups.

Preferably, R³ and R⁴, which are identical or different, represent a cyclic C₄-C₂₀, preferably C₇-C₂₀, preferably C₇-C₁₆, in particular C₇-C₁₀, alkyl group which can comprise one or more heteroatoms, preferably one or more oxygen atoms, and/or be optionally substituted by one or more hydroxyl groups.

Within the meaning of the present invention, the term “cyclic alkyl group” is understood to mean a linear or branched alkyl group additionally comprising a ring, preferably an aromatic ring, preferably comprising 5 or 6 ring members.

In other words, within the meaning of the present invention, a cyclic alkyl group comprises a linear or branched, preferably C₂-C₄, alkyl group and a ring, preferably an aromatic ring, preferably comprising 5 or 6 ring members.

Preferably, the cyclic alkyl group comprises a branched, preferentially C₂-C₄, alkyl group and an aromatic ring preferably comprising 5 or 6 ring members.

Preferably, R³ and R⁴, which are identical or different, represent an alkyl group, as defined above, which can be interrupted by one or more heteroatoms, preferably one or more oxygen atoms, and/or be optionally substituted by one or more hydroxyl groups.

Preferably, R³ and R⁴, which are identical or different, represent a linear, branched or cyclic C₁-C₂₀ alkyl group which can be optionally substituted by one or more hydroxyl groups.

Preferably, R³ represents a linear or branched C₄-C₂₀, preferably C₇-C₂₀, preferably C₇-C₁₆, in particular C₇-C₁₀, alkyl group which can comprise, preferably be interrupted by, one or more heteroatoms, preferably one or more oxygen atoms, and R⁴ represents a linear or branched C₁-C₇, preferably C₂-C₆, alkyl group optionally substituted by one or more hydroxyl groups, or a cyclic C₇-C₁₆, in particular C₇-C₁₀, alkyl group.

Preferably, R³ represents a branched C₇-C₂₀, preferably C₄-C₂₀, preferably C₇-C₁₆, in particular C₇-C₁₀, alkyl group which can comprise, preferably be interrupted by, one or more heteroatoms, preferably one or more oxygen atoms, and R⁴ represents a branched C₁-C₇, preferably C₂-C₆, alkyl group optionally substituted by one or more hydroxyl groups.

Preferably, the heteroatom is an oxygen atom.

Preferably, in the formula (II):
R³ represents a linear, branched or cyclic, preferably branched, C₄-C₂₀, preferably C₇-C₂₀, preferably C₇-C₁₆, in particular C₇-C₁₀, alkyl group which can comprise, preferably be interrupted by, one or more oxygen atoms, preferably one oxygen atom;
R⁴ represents:
   i) a linear or branched, preferably branched, C₇-C₂₀, preferably C₇-C₁₆, in particular C₇-C₉, alkyl group which can comprise, preferably be interrupted by, one or more oxygen atoms, preferably one oxygen atom;
   ii) a linear or branched, preferably branched, C₁-C₇, preferably C₂-C₆, alkyl group optionally substituted by one or more hydroxyl groups,
   iii) a cyclic C₇-C₁₀, in particular cyclic C₉, alkyl group.

Preferentially, in the formula (II), R³ represents a linear or branched, preferably branched, C₄-C₂₀, preferably C₇-C₂₀, preferably C₇-C₁₆, in particular C₇-C₁₀, alkyl group.

Preferentially, in the formula (II), R⁴ represents:
a linear or branched, preferably branched, C₁-C₇, preferably C₂-C₆, in particular C₄ or C₆, alkyl group optionally substituted by one or more hydroxyl groups,
a cyclic C₇-C₁₀, in particular C₉, alkyl group.

Preferentially, in the formula (II), when R⁴ represents a cyclic C₇-C₁₀ alkyl group, R⁴ then comprises a linear or branched, preferably branched, C₂-C₄, in particular C₃, alkyl group, and a ring, preferably an aromatic ring, preferably comprising 5 or 6 ring members.

More preferably still, R⁴ represents a linear or branched, preferably branched, C₁-C₇, preferably C₂-C₆, in particular C₆, alkyl group substituted by one or more hydroxyl groups, in particular one hydroxyl group.

Advantageously, in the formula (II):
R³ represents a linear or branched, preferably branched, C₄-C₂₀, preferably C₇-C₂₀, preferably C₇-C₁₆, in particular C₇-C₁₀, alkyl group,
R⁴ represents a linear or branched, preferably branched, C₁-C₇, preferably C₂-C₆, alkyl group optionally substituted by one or more hydroxyl groups.

The peroxyester is preferably chosen from the group consisting of α-cumyl peroxyneodecanoate, α-cumyl peroxyneoheptanoate, 2,4,4-trimethylpent-2-yl peroxyneodecanoate, tert-butyl peroxy(n-heptanoate), tert-butyl peroxyneodecanoate, α-cumyl peroxy(n-heptanoate), tert-amyl peroxy(n-heptanoate), tert-butyl peroxyneoheptanoate, 2,5-dimethyl-2,5-di(2-ethylhexanoylperoxy)hexane, tert-amyl peroxy(2-ethylhexanoate), tert-butyl peroxy(2-ethylhexanoate), 1,1,3,3-tetramethylbutyl peroxy(2-ethylhexanoate), hydroxyperoxyesters, tert-amyl peroxyneodecanoate, 1,1,3,3-tetramethylbutyl peroxyneodecanoate, 1,1,3,3-tetramethylbutyl peroxypivalate, tert-hexyl peroxyneodecanoate, tert-hexyl peroxypivalate and their mixtures.

Preferably, the peroxyesters are chosen from the group consisting of hydroxyperoxyesters.

The hydroxyperoxyesters are advantageously chosen from the group consisting of 4-hydroxy-2-methylpentyl peroxyneodecanoate, 4-hydroxy-2-methylpentyl peroxyneoheptanoate, 4-hydroxy-2-methylpentyl peroxy(2-ethylhexanoate), 4-hydroxy-2-methylpentyl peroxy(2-phenylbutyrate), 4-hydroxy-2-methylpentyl peroxy(2-phenoxypropionate), 4-hydroxy-2-methylpentyl peroxy(2-butyloctanoate), 4-hydroxy-2-methylpentyl peroxyneohexanoate, 4-hydroxy-2-methylpentyl peroxyneotridecanoate, 4-hydroxy-2-methylhexyl peroxyneohexanoate, 4-hydroxy-2-methylhexyl peroxyneodecanoate, 5-hydroxy-1,3,3-trimethylcyclohexyl peroxyneodecanoate, 4-hydroxy-2,6-dimethyl-2,6-di(neohexanoylperoxy)heptane, 4-hydroxy-2,6-dimethyl-2,6-di(neodecanoylperoxy)heptane, 3-hydroxy-1,1-dimethylbutyl peroxy(2-ethylhexanoate), 3-hydroxy-1,1-dimethylbutyl peroxyneodecanoate, 3-hydroxy-1,1-dimethylbutyl peroxyneoheptanoate and their mixtures, preferably 3-hydroxy-1,1-dimethylbutyl peroxyneodecanoate.

Preferably, the peroxyester is chosen from the group consisting of tert-butyl peroxyneodecanoate, tert-amyl peroxyneodecanoate, α-cumyl peroxyneoheptanoate, hydroxyperoxyesters and their mixtures.

Preferably, the peroxyester is chosen from the group consisting of 3-hydroxy-1,1-dimethylbutyl peroxyneodecanoate, sold under the trade name Luperox® 610 by Arkema, α-cumyl peroxyneoheptanoate, sold under the trade name Luperox® 188, tert-amyl peroxyneodecanoate, sold under the trade name Luperox® 546, and tert-butyl peroxyneodecanoate, sold under the trade name Luperox® 10 by Arkema, and their mixtures.

Preferably, the peroxyester is chosen from the group consisting of 3-hydroxy-1,1-dimethylbutyl peroxyneodecanoate, sold under the trade name Luperox® 610 by Arkema, and tert-butyl peroxyneodecanoate, sold under the trade name Luperox® 10 by Arkema, and their mixtures.

Advantageously, the peroxyester is 3-hydroxy-1,1-dimethylbutyl peroxyneodecanoate, sold under the trade name Luperox® 610 by Arkema.

Preferably, the peroxydicarbonate/peroxyester ratio by weight varies from 1/99 to 99/1, preferentially from 2/98 to 98/2.

According to another embodiment, the peroxydicarbonate/peroxyester ratio by weight varies from 10/90, in particular from 20/80, to 50/50.

According to another embodiment, the peroxydicarbonate/peroxyester ratio by weight varies from 99/1, in particular from 97/3, in particular 90/10 and preferentially 80/20, to 50/50.

The peroxydicarbonate and the peroxyester advantageously have a one hour half-life temperature of less than or equal to 90° C., preferably of less than 90° C.

Furthermore, the peroxydicarbonate and the peroxyester advantageously have a storage temperature of less than 0° C.

Preferably, the process according to the invention comprises the mixing:
(i) of at least one organic peroxide of formula (I):

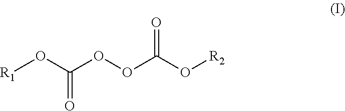

in which formula (I) R¹ and R², which are identical or different, represent a linear, branched or cyclic C₁-C₂₀ alkyl group which can comprise one or more heteroatoms, preferably one or more oxygen atoms; and
(ii) of at least one organic peroxide of formula (II):

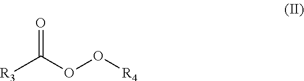

in which formula (II) R³ and R⁴, which are identical or different, represent a linear, branched or cyclic C₁-C₂₀ alkyl group which can comprise one or more heteroatoms, preferably one or more oxygen atoms, and/or be optionally substituted by one or more hydroxyl groups.

Preferably, the process according to the invention comprises the mixing:
(i) of at least one organic peroxide of formula (I):

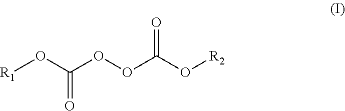

in which formula (I) R¹ and R² are identical and represent a linear or branched, preferably branched, C₁-C₁₆, in particular C₃-C₁₂, more preferentially still C₃-C₁₀, alkyl group; and
(ii) of at least one organic peroxide of formula (II):

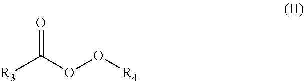

in which formula (II):
   R³ represents a linear, branched or cyclic, preferably branched, C₄-C₂₀, preferably C₇-C₂₀, preferably C₇-C₁₆, in particular C₇-C₉, alkyl group which can comprise, preferably be interrupted by, one or more oxygen atoms, preferably one oxygen atom;
   R⁴ represents:
   i) a linear or branched, preferably branched, C₇-C₂₀, preferably C₇-C₁₆, in particular C₇-C₁₀, alkyl group which can comprise, preferably be interrupted by, one or more oxygen atoms, preferably one oxygen atom;
   ii) a linear or branched, preferably branched, C₁-C₇, preferably C₂-C₆, alkyl group optionally substituted by one or more hydroxyl groups,
   iii) a cyclic C₇-C₁₀, in particular cyclic C₉, alkyl group.

Advantageously, in accordance with this preferred embodiment, in the formula (I), R¹ and R² are identical and represent a linear or branched, preferably branched, C₁-C₆, in particular C₁-C₄, alkyl group.

Advantageously again, in accordance with this preferred embodiment, in the formula (I), R¹ and R² are identical and represent a linear or branched, preferably branched, C₇-C₁₆, in particular C₇-C₁₂, more preferentially still C₇-C₉, alkyl group.

Advantageously again, in accordance with this preferred embodiment, in the formula (II), R⁴ represents a linear or branched, preferably branched, C₁-C₇, preferably C₂-C₆, alkyl group optionally substituted by one or more hydroxyl groups.

Advantageously again, in accordance with this preferred embodiment, in the formula (II), R⁴ represents a linear or branched, preferably branched, C₁-C₇, preferably C₂-C₆, alkyl group substituted by one or more hydroxyl groups, in particular one hydroxyl group.

More advantageously, the process according to the invention comprises the mixing:
(a) of at least one organic peroxide of formula (I) chosen from the group consisting of di(2-ethylhexyl) peroxydicarbonate, in particular sold under the trade name Luperox® 223, di(sec-butyl) peroxydicarbonate, in particular sold under the trade name Luperox® 225, and their mixtures; and
(b) of at least one organic peroxide of formula (II) chosen from the group consisting of tert-butyl peroxyneodecanoate, sold under the trade name Luperox® 10, tert-amyl peroxyneodecanoate, sold under the trade name Luperox® 546, α-cumyl peroxyneoheptanoate, sold under the trade name Luperox® 188, and hydroxyperoxyesters, as defined above, preferably 3-hydroxy-1,1-dimethylbutyl peroxyneodecanoate, in particular sold under the trade name Luperox® 610.

In accordance with this advantageous embodiment, the organic peroxide of formula (II) is chosen from tert-butyl peroxyneodecanoate and hydroxyperoxyesters.

Advantageously again, in accordance with this embodiment, the organic peroxide of formula (II) is a hydroxyperoxyester, preferably 3-hydroxy-1,1-dimethylbutyl peroxyneodecanoate.

Preferably, the process according to the invention comprises the mixing:
(i) of at least one peroxydicarbonate, as defined above, and
(ii) of at least one peroxyester of formula (II), as defined above, preferably chosen from the group consisting of tert-butyl peroxyneodecanoate, in particular sold under the trade name Luperox® 10, tert-amyl peroxyneodecanoate, sold under the trade name Luperox® 546, tert-amyl peroxyneodecanoate, sold under the trade name Luperox® 546, and hydroxyperoxyesters, preferably 3-hydroxy-1,1-dimethylbutyl peroxyneodecanoate, in particular the 3-hydroxy-1,1-dimethylbutyl peroxyneodecanoate sold under the trade name Luperox® 610.

Preferably, the process according to the invention comprises the mixing of at least one peroxydicarbonate and of at least one peroxyester, as are defined above, in an aqueous phase.

The aqueous phase preferentially comprises at least one emulsifying agent and water.

The water can be present in a content ranging from 50% to 98% by weight, with respect to the total weight of the composition.

Preferably, the process according to the invention comprises the addition of at least one emulsifying agent.

Preferably, the emulsifying agent is chosen from the group consisting of cellulose ether derivatives, partially hydrolysed poly(vinyl acetates), non-ionic surfactants and their mixtures.

The non-ionic surfactant, which is or is not oxyalkylenated, is preferably chosen from the group consisting of fatty alcohols, fatty acids, (hydrogenated or non-hydrogenated) vegetable or animal oils, glucoside esters, sorbitan esters (Span), alkoxylated sorbitan esters (Tween); or their mixtures.

Preferably, the emulsifying agent is chosen from the group consisting of partially hydrolysed poly(vinyl acetates).

More preferentially, the emulsifying agent is chosen from the group consisting of poly(vinyl acetates) having a degree of hydrolysis ranging from 70% to 90% or a degree of hydrolysis ranging from 40% to 60%.

The process according to the invention can also comprise the addition of one or more additives intended to provide the final composition with specific properties/characteristics. These additives will ideally be present for the final polymerization or copolymerization.

The additive can be chosen from the group consisting of anti-foaming agents, chain-transfer agents, chain extenders, pH regulators, plasticizers and their mixtures.

Preferably, the process according to the invention comprises the addition of at least one plasticizer, preferably chosen from the group consisting of phthalates, adipates, benzoates and the hydrogenated derivatives of these molecules, including in particular diisononylcyclohexane and diisononyl cyclohexanedicarboxylate and their mixtures

Preferably, in the process according to the invention, the mixture of at least one peroxydicarbonate and of at least one peroxyester, as are defined above, is employed at a temperature ranging from −10° C. to 50° C., in particular at a temperature ranging from 0° C. to 30° C.

Preferably, the composition obtained according to the process according to the invention is liquid, in particular at a temperature ranging from −10° C. to 50° C., especially at a temperature ranging from 0° C. to 30° C.

Preferably, the process according to the invention comprises at least:
(a) the mixing of at least one peroxydicarbonate and of at least one peroxyester, as are defined above, in an aqueous phase as defined above,
(b) the emulsification of said mixture.

In particular, the process according to the invention successively comprises:
(a) the mixing of at least one peroxydicarbonate and of at least one peroxyester, as are defined above, in an aqueous phase as defined above,
(b) the emulsification of said mixture.

More particularly, the process according to the invention successively comprises:
the addition of at least one emulsifying agent, as defined above, to water, in order to obtain an aqueous phase,
the mixing of at least one peroxydicarbonate and of at least one peroxyester, as are defined above, in the aqueous phase,
the emulsification of said mixture.

Preferably, the peroxydicarbonate and/or the peroxyester is (or are) diluted using at least one organic solvent or is (or are) in the aqueous emulsion form before being mixed in accordance with the process according to the invention.

In other words, before mixing, the peroxydicarbonate and/or the peroxyester can be in a composition existing in a liquid form diluted by at least one organic solvent or placed in aqueous emulsion.

Preferably, the peroxydicarbonate and the peroxyester are diluted using at least one organic solvent or are in the aqueous emulsion form before being mixed in accordance with the process according to the invention.

More preferentially, the peroxydicarbonate and the peroxyester are in the aqueous emulsion form before being mixed in accordance with the process according to the invention.

In other words, the process for the preparation of the composition of organic peroxides comprises the mixing of at least one peroxydicarbonate, as defined above, and of at least one peroxyester, as defined above, before bringing said composition into contact with one or more ethylenically unsaturated monomers; at least one of said organic peroxides, preferably said organic peroxides, being in the form of an aqueous emulsion.

Preferentially, the process for the preparation of the composition of organic peroxides comprises the mixing of at least one peroxydicarbonate, as defined above, being in the form of an aqueous emulsion, and of at least one peroxyester, as defined above, being in the form of an aqueous emulsion, before bringing the composition thus obtained into contact with one or more ethylenically unsaturated monomers.

Alternatively, the peroxydicarbonate and/or the peroxyester is (or are) in the pure form.

In particular, the peroxydicarbonate and the peroxyester are in the pure form.

According to one embodiment, the process for the preparation of the composition of organic peroxides comprises the mixing of at least one peroxydicarbonate, as defined above, being in the pure form, and of at least one peroxyester, as defined above, being in the pure form, before bringing the composition thus obtained into contact with one or more ethylenically unsaturated monomers.

According to a preferential characteristic of the invention, the process for the preparation of the composition comprises the mixing of at least one peroxydicarbonate and of at least one peroxyester, before the introduction of the composition thus obtained into a polymerization reactor, said polymerization reactor preferably comprising one or more ethylenically unsaturated monomers.

Thus, the process advantageously employs a mixture prepared before injection of the composition into a polymerization reactor, said polymerization reactor preferably comprising one or more ethylenically unsaturated monomers.

According to another preferential characteristic, the process according to the invention comprises the mixing of at least one peroxydicarbonate and of at least one peroxyester in an aqueous phase devoid of the ethylenically unsaturated monomer(s) described above.

Preferably, the ethylenically unsaturated monomers are chosen from the group consisting of vinyl halide monomers (i.e., halogenated vinyl monomers) and more preferentially vinyl chloride.

Advantageously, the process according to the invention comprises the addition of at least one peroxyester, as defined above, to a composition comprising at least one peroxydicarbonate, as defined above.

Thus, the stage of mixing the organic peroxides is advantageously a stage of addition of at least one peroxyester, as defined above, to a composition comprising at least one peroxydicarbonate, as defined above.

In accordance with this advantageous embodiment, the peroxydicarbonate/peroxyester ratio by weight varies preferably from 99/1, in particular from 97/3, especially 90/10 and preferentially 80/20, to 50/50.

In accordance with this embodiment, the addition of at least one peroxyester makes it possible to improve the peroxydicarbonate stability.

### Polymerization Process

Another subject-matter of the invention is a process for the polymerization of one or more ethylenically unsaturated monomers successively comprising:
(i) the preparation of a composition in accordance with the process as described above,
(ii) bringing said composition into contact with one or more ethylenically unsaturated monomers.

Preferably, stage (ii) of bringing into contact is carried out at least 30 minutes after stage (i), preferably at least 1 hour after stage (i).

Preferably, the process is a process of polymerization of one or more vinyl monomers, preferably halogenated vinyl monomers, and more preferentially of vinyl chloride.

Mention may be made, as ethylenically unsaturated monomers, of acrylates, vinyl esters, vinyl halide monomers, vinyl ethers, butadiene or vinylaromatic compounds, such as styrene.

Preferably, the ethylenically unsaturated monomers are chosen from the group consisting of vinyl halide monomers (i.e., halogenated vinyl monomers) and more preferentially vinyl chloride.

Preferably, bringing the composition into contact with one or more ethylenically unsaturated monomers comprises the introduction of said composition into a polymerization reactor comprising the ethylenically unsaturated monomer(s).

Preferably, the preparation of the composition in accordance with the process described above takes place in a separate reactor from the reactor in which the composition is brought into contact with the ethylenically unsaturated monomer(s) described above.

Preferably, stage (i) of preparation of the composition can be used for several polymerizations. In other words, stage (i) of preparation of the composition can be followed by several stages (ii) of bringing said composition into contact with one or more ethylenically unsaturated monomers.

### Use

The present invention also relates to the use of the composition as defined above for the polymerization or the copolymerization of one or more ethylenically unsaturated monomers, in particular vinyl monomers, preferably halogenated vinyl monomers, and more preferentially vinyl chloride.

In particular, the composition is used for the manufacture of a halogenated vinyl polymer, preferably poly(vinyl chloride).

Preferentially, the invention relates to the use of at least one peroxyester, as described above, for improving the stability of at least one peroxydicarbonate, as described above.

### Polymer

Another subject-matter of the present invention relates to the halogenated vinyl polymer obtained by polymerization of at least one ethylenically unsaturated monomer, as defined above, in the presence of the composition as defined above.

Preferably, the invention relates to the poly(vinyl chloride) obtained by polymerization of vinyl chloride in the presence of the composition as obtained by the process as defined according to the invention, in particular in the presence of a mixture of organic peroxides, as are defined above.

The following examples serve to illustrate the invention without, however, exhibiting a limiting nature.

### EXAMPLES

### Example 1

The following composition I was prepared from the ingredients, mentioned in the table below, the contents of which have been shown as percentage by weight, with respect to the total weight of the composition.

TABLE 1

| | |
|---|---|
| Di(2-ethylhexyl) peroxydicarbonate (Luperox ® 223) | 11.3% |
| 3-Hydroxy-1,1-dimethylbutyl peroxyneodecanoate | 2% |
| Polyvinyl alcohol | |
| (Alcotex 552 P) | |
| Polyvinyl alcohol | |
| (Gohsenol GH20) | |
| Water | Q.s. for 100 |

### Tests Carried Out:

The content by weight of peroxydicarbonate (di(2-ethylhexyl) peroxydicarbonate—Luperox® 223) was measured at a temperature of 15° C. over a period of 96 hours:
in the composition I in the presence of a peroxyester (3-hydroxy-1,1-dimethylbutyl peroxyneodecanoate—Luperox® 610),
in a composition identical to the composition I but devoid of peroxyester; the peroxyester being replaced by water.

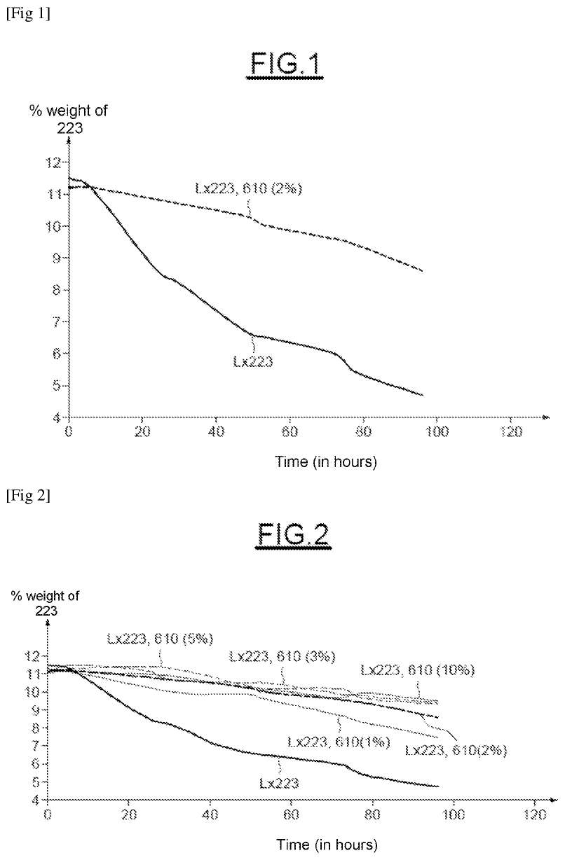

FIG. 1 represents, on the one hand, the content by weight of di(2-ethylhexyl) peroxydicarbonate alone, curve referenced Lx 223, and, on the other hand, the content by weight of the peroxydicarbonate in the presence of 2% by weight of 3-hydroxy-1,1-dimethylbutyl peroxyneodecanoate, curve referenced Lx 223, 610, as a function of the time.

### Results

FIG. 1 shows that the content by weight of di(2-ethylhexyl) peroxydicarbonate decreases less rapidly in the presence of 3-hydroxy-1,1-dimethylbutyl peroxyneodecanoate over a period of 96 hours at a temperature of 15° C. than when the di(2-ethylhexyl) peroxydicarbonate is alone in the composition.

The results thus demonstrate that di(2-ethylhexyl) peroxydicarbonate is more stable in the presence of 3-hydroxy-1,1-dimethylbutyl peroxyneodecanoate than alone in the same composition.

### Example II

In the following example, the content by weight of di(2-ethylhexyl) peroxydicarbonate was measured at a temperature of 15° C. over a period of 96 hours:
in the composition I in the presence of the peroxyester (3-hydroxy-1,1-dimethylbutyl peroxyneodecanoate—Luperox® 610),
in a composition identical to the composition I but devoid of peroxyester,
in a composition identical to the composition I but comprising 1% by weight of peroxyester,
in a composition identical to the composition I but comprising 3% by weight of peroxyester,
in a composition identical to the composition I but comprising 5% by weight of peroxyester,
in a composition identical to the composition I but comprising 10% by weight of peroxyester,

FIG. 2 represents, as a function of the time:
the content by weight of di(2-ethylhexyl) peroxydicarbonate alone, curve referenced Lx 223,
the content by weight of peroxydicarbonate in the presence of 1% by weight of 3-hydroxy-1,1-dimethylbutyl peroxyneodecanoate, curve referenced Lx 223, 610 (1%),
the content by weight of peroxydicarbonate in the presence of 2% by weight of 3-hydroxy-1,1-dimethylbutyl peroxyneodecanoate, curve referenced Lx 223, 610 (2%),
the content by weight of peroxydicarbonate in the presence of 3% by weight of 3-hydroxy-1,1-dimethylbutyl peroxyneodecanoate, curve referenced Lx 223, 610 (3%),
the content by weight of peroxydicarbonate in the presence of 5% by weight of 3-hydroxy-1,1-dimethylbutyl peroxyneodecanoate, curve referenced Lx 223, 610 (5%),
the content by weight of peroxydicarbonate in the presence of 10% by weight of 3-hydroxy-1,1-dimethylbutyl peroxyneodecanoate, curve referenced Lx 223, 610 (10%).

### Results

FIG. 2 shows that the content by weight of di(2-ethylhexyl) peroxydicarbonate decreases less rapidly in the presence of 3-hydroxy-1,1-dimethylbutyl peroxyneodecanoate over a period of 96 hours at a temperature of 15° C. than when the di(2-ethylhexyl) peroxydicarbonate is alone in the composition.

The results thus demonstrate that di(2-ethylhexyl) peroxydicarbonate is more stable in the presence of 3-hydroxy-1,1-dimethylbutyl peroxyneodecanoate than alone in the same composition.

### Example III

In the following example, the content by weight of di(2-ethylhexyl) peroxydicarbonate was measured at a temperature of 15° C. over a period of 96 hours:
in the composition I in the presence of 2% by weight of peroxyester (3-hydroxy-1,1-dimethylbutyl peroxyneodecanoate—Luperox® 610),
in a composition identical to the composition I but devoid of peroxyester,
in a composition identical to the composition I but comprising 2.5% by weight of tert-butyl peroxyneodecanoate (Luperox® 10).

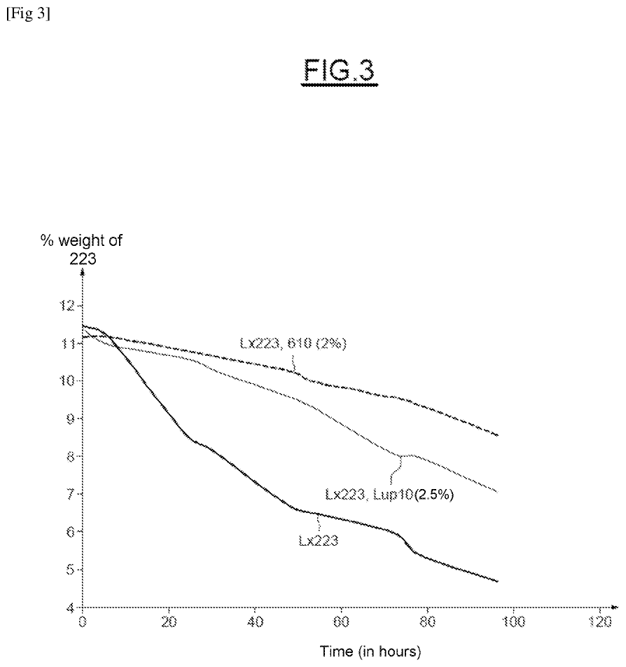

FIG. 3 represents, as a function of the time:
the content by weight of di(2-ethylhexyl) peroxydicarbonate alone, curve referenced Lx 223,
the content by weight of peroxydicarbonate in the presence of 2% by weight of 3-hydroxy-1,1-dimethylbutyl peroxyneodecanoate, curve referenced Lx 223, 610 (2%).
the content by weight of peroxydicarbonate in the presence of 2.5% by weight of tert-butyl peroxyneodecanoate, curve referenced Lx 223, Lup10 (2.5%).

### Results

FIG. 3 shows that the content by weight of di(2-ethylhexyl) peroxydicarbonate decreases less rapidly in the presence of a peroxyester over a period of 96 hours at a temperature of 15° C. than when the di(2-ethylhexyl) peroxydicarbonate is alone in the composition.

The results thus demonstrate that di(2-ethylhexyl) peroxydicarbonate is more stable in the presence of a peroxyester than alone in the same composition and under the same conditions.

Furthermore, it is found that di(2-ethylhexyl) peroxydicarbonate is more stable in the presence of the hydroxyperoxyester, namely 3-hydroxy-1,1-dimethylbutyl peroxyneodecanoate.

1. Process for the preparation of a composition of organic peroxides comprising the mixing of at least one peroxydicarbonate and of at least one peroxyester before bringing said composition into contact with one or more ethylenically unsaturated monomers.

2. Process according to claim 1, characterized in that the peroxydicarbonate corresponds to the following formula (I): 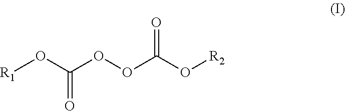
in which formula (I) R¹ and R², which are identical or different, represent a linear, branched or cyclic C₁-C₂₀ alkyl group which can comprise one or more heteroatoms, preferably one or more oxygen atoms.

3. Process according to claim 2, characterized in that R¹ and R², which are identical or different, represent a linear or branched C₁-C₁₆, more preferentially C₃-C₁₂, in particular C₃-C₁₀, alkyl group which can comprise, preferably be interrupted by, one or more heteroatoms, preferably one or more oxygen atoms.

4. Process according to any one of claims 1 to 3, characterized in that R¹ and R² are identical and represent a linear or branched, preferably branched, C₂-C₈ alkyl group.

5. Process according to any one of the preceding claims, characterized in that the peroxydicarbonate is chosen from the group consisting of di(2-ethylhexyl) peroxydicarbonate, di(sec-butyl) peroxydicarbonate, bis(1-methylheptyl) peroxydicarbonate, di(n-propyl) peroxydicarbonate, di(3-methoxybutyl) peroxydicarbonate, diethyl peroxydicarbonate and their mixtures.

6. Process according to any one of the preceding claims, characterized in that the peroxyester corresponds to the following general formula (II): 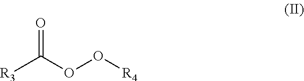
in which formula (II) R³ and R⁴, which are identical or different, represent a linear, branched or cyclic C₁-C₂₀ alkyl group which can comprise, preferably be interrupted by, one or more heteroatoms, preferably one or more oxygen atoms, and/or be optionally substituted by one or more hydroxyl groups.

7. Process according to claim 6, characterized in that:
R³ represents a linear, branched or cyclic, preferably branched, C₄-C₂₀, preferably C₇-C₂₀, preferably C₇-C₁₆, in particular C₇-C₁₀, alkyl group which can comprise, preferably be interrupted by, one or more oxygen atoms, preferably one oxygen atom;
R₄ represents:
i) a linear or branched, preferably branched, C₇-C₂₀, preferably C₇-C₁₆, in particular C₇-C₁₀, alkyl group which can comprise, preferably be interrupted by, one or more oxygen atoms, preferably one oxygen atom;
ii) a linear or branched, preferably branched, C₁-C₇, preferably C₂-C₆, alkyl group optionally substituted by one or more hydroxyl groups;
iii) a cyclic C₇-C₁₀, in particular cyclic C₉, alkyl group.

8. Process according to any one of the preceding claims, characterized in that the peroxyester is chosen from the group consisting of α-cumyl peroxyneodecanoate, α-cumyl peroxyneoheptanoate, 2,4,4-trimethylpent-2-yl peroxyneodecanoate, tert-butyl peroxy(n-heptanoate), tert-butyl peroxyneodecanoate, α-cumyl peroxy(n-heptanoate), tert-amyl peroxy(n-heptanoate), tert-butyl peroxyneoheptanoate, 2,5-dimethyl-2,5-di(2-ethylhexanoylperoxy)hexane, tert-amyl peroxy(2-ethylhexanoate), tert-butyl peroxy(2-ethylhexanoate), 1,1,3,3-tetramethylbutyl peroxy(2-ethylhexanoate), hydroxyperoxyesters, tert-amyl peroxyneodecanoate, 1,1,3,3-tetramethylbutyl peroxyneodecanoate, 1,1,3,3-tetramethylbutyl peroxypivalate, tert-hexyl peroxyneodecanoate, tert-hexyl peroxypivalate and their mixtures.

9. Process according to any one of the preceding claims, characterized in that the peroxyester is a hydroxyperoxyester chosen from the group consisting of 4-hydroxy-2-methylpentyl peroxyneodecanoate, 4-hydroxy-2-methylpentyl peroxyneoheptanoate, 4-hydroxy-2-methylpentyl peroxy(2-ethylhexanoate), 4-hydroxy-2-methylpentyl peroxy(2-phenylbutyrate), 4-hydroxy-2-methylpentyl peroxy(2-phenoxypropionate), 4-hydroxy-2-methylpentyl peroxy(2-butyloctanoate), 4-hydroxy-2-methylpentyl peroxyneohexanoate, 4-hydroxy-2-methylpentyl peroxyneotridecanoate, 4-hydroxy-2-methylhexyl peroxyneohexanoate, 4-hydroxy-2-methylhexyl peroxyneodecanoate, 5-hydroxy-1,3,3-trimethylcyclohexyl peroxyneodecanoate, 4-hydroxy-2,6-dimethyl-2,6-di(neohexanoylperoxy)heptane, 4-hydroxy-2,6-dimethyl-2,6-di(neodecanoylperoxy)heptane, 3-hydroxy-1,1-dimethylbutyl peroxy(2-ethylhexanoate), 3-hydroxy-1,1-dimethylbutyl peroxyneodecanoate, 3-hydroxy-1,1-dimethylbutyl peroxyneoheptanoate and their mixtures, preferably 3-hydroxy-1,1-dimethylbutyl peroxyneodecanoate.

10. Process according to any one of the preceding claims, characterized in that the peroxyester is chosen from the group consisting of tert-butyl peroxyneodecanoate, tert-amyl peroxyneodecanoate, α-cumyl peroxyneoheptanoate and hydroxyperoxyesters.

11. Process according to any one of the preceding claims, characterized in that it comprises the mixing of at least one peroxydicarbonate and of at least one peroxyester in an aqueous phase.

12. Process according to any one of the preceding claims, characterized in that the peroxydicarbonate and/or the peroxyester is (or are) diluted using at least one organic solvent or is (or are) in the aqueous emulsion form.

13. Process according to any one of the preceding claims, characterized in that it comprises the addition of at least one emulsifying agent, preferably chosen from the group consisting of cellulose ether derivatives, partially hydrolysed poly(vinyl acetates), non-ionic surfactants and their mixtures.

14. Process according to any one of the preceding claims, characterized in that the mixture is prepared at a temperature ranging from −10° C. to 50° C., preferably at a temperature ranging from 0° C. to 30° C.

15. Process according to any one of the preceding claims, characterized in that the mixture is prepared before injection of said composition into a polymerization reactor comprising one or more ethylenically unsaturated monomers.

16. Process for the polymerization of one or more ethylenically unsaturated monomers successively comprising:
(i) the preparation of a composition in accordance with the process as defined according to any one of claims 1 to 14,
(ii) bringing said composition into contact with one or more ethylenically unsaturated monomers.

17. Use of the composition obtained according to any one of claims 1 to 13 for the polymerization or the copolymerization of one or more ethylenically unsaturated monomers.

18. Use according to claim 17, characterized in that the ethylenically unsaturated monomers are halogenated vinyl monomers and more preferentially vinyl chloride.

19. Halogenated vinyl polymer obtained by polymerization of at least one ethylenically unsaturated monomer in the presence of a composition as defined according to any one of claims 1 to 13.
